(19) United States
(12) Patent Application Publication
(10) Pub. No.: US 2014/0177615 A1
(43) Pub. Date: Jun. 26, 2014

(54) METHOD FOR SCANNING A WIRELESS FIDELITY (WI-FI) DIRECT DEVICE AND TERMINAL DEVICE FOR THE SAME

(71) Applicant: Pantech Co., Ltd., Seoul (KR)

(72) Inventors: Tae Hun KIM, Seoul (KR); Jong Hyun Park, Seoul (KR)

(73) Assignee: Pantech Co., Ltd., Seoul (KR)

(21) Appl. No.: 14/132,834

(22) Filed: Dec. 18, 2013

(30) Foreign Application Priority Data
Dec. 20, 2012 (KR) 10-2012-0149811

(51) Int. Cl. H04W 8/00; H04W 76/02

(52) U.S. Cl. CPC H04W 8/005; H04W 76/023
USPC 370/338

(57) ABSTRACT

A method and a terminal device for scanning a Wireless Fidelity (Wi-Fi) direct device in a terminal device are described. The method includes: activating a Wi-Fi direct operation; scanning Wi-Fi direct devices within range to obtain device information; determining, with a processor, whether connection is available or non-available with each of the scanned Wi-Fi direct devices by analyzing the device information for each of the scanned Wi-Fi direct devices; and displaying the available Wi-Fi direct devices. Accordingly, a user may distinguish the available devices from the non-available devices.

### CROSS-REFERENCE TO RELATED APPLICATION

This application claims priority to and all benefits under 35 U.S.C. §119 from Korean Patent Application No. 10-2012-0149811, filed on Dec. 20, 2012, the contents of which in its entirety is herein incorporated by reference.

### BACKGROUND

1. Field

Exemplary embodiments relate to a method for scanning and connecting a Wireless Direct (Wi-Fi) direct device and a terminal device for the same, and more particularly, a method for scanning and connecting a Wi-Fi direct device to provide a Wi-Fi direct service and a terminal device for the same.

2. Description of the Background

In recent years, with development of electronic and communication technologies, technologies using wireless communication technologies have tended to be widely used not only in the field of communication but also in other industry fields. Accordingly, a variety of services, such as, voice call, data transmission, and the Internet have been provided on wireless networks. Examples of the representative wireless communication technologies and networks include Wireless Broadband Internet (WiBro) and Wireless Fidelity (Wi-Fi).

The Wi-Fi is one of the short-range wireless communication technologies based on the IEEE 802.11 standard and is a WLAN (Wireless Local Area Network) technology capable of enabling high-performance wireless communication by integrating a wireless technology with Hi-Fi (High Fidelity). The WLAN technology refers to a scheme of constructing a network using radio waves, infrared rays, or the like without use of wired lines when the network is constructed.

When such a Wi-Fi technology is used, a Portable Computer (PC), such as, a notebook type computer can be wirelessly connected in a neighborhood place. When the Wi-Fi technology is used, a plurality of PCs can be connected, and large files, graphics, videos, and audios can be transmitted. Wi-Fi wireless Ethernets currently realized in mobile terminals can provide a speed of 433.3 Mega Bit per second (Mbps) and may be used within a radius of approximately 500 m from a wireless transceiver under an optimum condition. Wireless networks can be used in either households or work places.

In recent years, users have used mobile terminals, such as, smartphones using Wi-Fi, to make Wi-Fi connections. The mobile terminals are used for ordinary telephone calls, schedule management, and the like, and are widely used for game, image photographing, display, and the like, and thus the application ranges have expanded.

The Wi-Fi provides communication service, such as, the Internet, to portable terminals (for example, Personal Digital Assistant (PDA) and notebook type computers) located within a range or given distance of an access point (AP) antenna serving as a wireless connection device.

In recent years, a Wi-Fi direct technology for enabling printing, contents sharing, or the like by freely performing communication between Wi-Fi devices without an AP or a router has been developed. The Wi-Fi direct technology may be configured by a group administrator (P2P Group Owner) that administrates a specific group, a group member (P2P Client) that belongs to the specific group, and a P2P device that does not belong to the specific group.

In order to perform Wi-Fi direct connection, a mobile terminal first transmits a scan request signal to scan terminals and receives response signals from neighborhood terminals. The mobile terminal generates a list of the terminals present in a range or vicinity of the mobile terminal using the response signal received in the above way.

In this case, it is not distinguished whether the terminals displayed in the list are a terminal of a specific group administrator (P2P Group Owner), a terminal of a group member (P2P Client) belonging to a specific group, or a device (hereinafter, referred to as a concurrent device) that simultaneously supports the group administrator and the group member. Even non-available devices are displayed. Accordingly, the users may not know whether Wi-Fi direct connection with the scanned devices is possible before attempting connection, a user's attempt to connect with a non-available device may fail, and the user may not know why the connection failed.

### SUMMARY

According to exemplary embodiments, there is provided a method for scanning and connecting to a Wi-Fi direct device, which can distinguish a Wi-Fi direct available device from a non-available device. According to exemplary embodiments, there is provided a terminal device that performs the method.

According to exemplary embodiments, there is provided a method for scanning and connecting the Wi-Fi direct device and the terminal device for the same, where users can intuitively understand whether connection with a Wi-Fi direct device is possible, and thus the user can efficiently use a Wi-Fi direct service.

Exemplary embodiments of the present invention disclose a terminal device to scan a Wi-Fi direct device, the terminal device including: a scan unit configured to activate a Wi-Fi direct operation and configured to scan for Wi-Fi direct devices in range to obtain device information; a control unit configured to determine whether connection is available or non-available with each of the scanned Wi-Fi direct devices by analyzing the device information for each of the scanned Wi-Fi direct devices; and a display unit configured to display the available Wi-Fi direct devices.

Exemplary embodiments of the present invention disclose a method for scanning a Wi-Fi direct device in a terminal device, the method including: activating a Wi-Fi direct operation; scanning Wi-Fi direct devices within range to obtain device information; determining, with a processor, whether connection is available or non-available with each of the scanned Wi-Fi direct devices by analyzing the device information for each of the scanned Wi-Fi direct devices; and displaying the available Wi-Fi direct devices.

Exemplary embodiments of the present invention disclose a non-transitory computer readable medium including an executable program which, when executed, performs a method for scanning a Wi-Fi direct device in a terminal device, the method including: activating a Wi-Fi direct operation; scanning Wi-Fi direct devices within range to obtain device information; determining whether connection is available or non-available with each of the scanned Wi-Fi direct devices by analyzing the device information for each of the scanned Wi-Fi direct devices; and displaying the available Wi-Fi direct devices.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a terminal device according to exemplary embodiments of the present disclosure.

FIG. 2 is a flowchart illustrating a selection process in which the terminal device operates as a group owner or a P2P device according to exemplary embodiments.

FIG. 3 is a flowchart illustrating a process in which the terminal device operates as the group owner according to exemplary embodiments.

FIG. 4A and FIG. 4B are diagrams illustrating exemplary screens when a terminal device operates as a group owner that does not support a concurrent operation according to exemplary embodiments.

FIG. 5A and FIG. 5B are diagrams illustrating exemplary screens when a terminal device operates as a group owner that does not support a concurrent operation according to exemplary embodiments.

FIG. 6 is a diagram illustrating an exemplary screen when a terminal operates as a group owner that supports a concurrent operation according to exemplary embodiments.

FIG. 7A and FIG. 7B are diagrams illustrating exemplary screens when a terminal device operates as a group owner that supports a concurrent operation according to exemplary embodiments.

FIG. 8 is a flowchart illustrating a process in which the terminal device operates as the P2P device according to exemplary embodiments.

FIG. 9A and FIG. 9B are diagrams illustrating exemplary screens when a P2P device operates as a group client that does not support a concurrent operation according to exemplary embodiments.

FIG. 10A and FIG. 10B are diagrams illustrating exemplary screens when a P2P device operates as a group client that does not support a concurrent operation according to exemplary embodiments.

FIG. 11 is a diagram illustrating an exemplary screen when a P2P device operates as a group client that does not support the concurrent operation according to exemplary embodiments.

FIG. 12 is a diagram illustrating an exemplary screen when a P2P device operates as a group client that does not support the concurrent operation according to exemplary embodiments.

FIG. 13A and FIG. 13B are diagrams illustrating exemplary screens when a P2P device operates as a group client and a group owner that supports a concurrent operation according to exemplary embodiments.

FIG. 14A and FIG. 14B are diagrams illustrating exemplary screens when a P2P device operates as a group client and a group owner that supports a concurrent operation according to exemplary embodiments.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

Hereinafter, exemplary embodiments of a method for scanning and connecting a Wi-Fi direct device and a terminal device for the same will be described in more detail with reference to the accompanying drawings.

Hereinafter, the Wi-Fi direct device may operate as one of a group owner, a group client, and a Peer-to-Peer (P2P) device.

The group owner is a Wi-Fi direct device that operates as a Wi-Fi Access Point (AP), communicates with a group client, and permits a Wi-Fi station connection with the group client. The role of a P2P group owner is defined as:
“AP-like” entity that provides BSS functionality and services for associated Clients (P2P Clients or Legacy Clients);
Provides WPS Internal Registrar functionality;
May provide communication between associated Clients; and
May provide access to a simultaneous WLAN connection for its associated Clients.

The group client refers to a Wi-Fi direct device that operates as a Wi-Fi station. The role of a P2P Client is defined as:
Implements non-AP STA functionality; and
Provides WPS enrollee functionality.

The P2P device refers to a Wi-Fi direct device that supports both the roles of a group owner and a group client and attempts to connect with another device. The role of a P2P device is defined as:
Supports both P2P Group Owner and P2P Client roles;
Negotiates P2P Group Owner or P2P Client role;
Supports WPS and P2P Discovery mechanism; and
May support WLAN and P2P concurrent operation.

The Wi-Fi direct device may support a concurrent operation (concurrent) or may not support a concurrent operation (non-concurrent). A Wi-Fi direct device that supports the concurrent operation may operate as an owner of a group and may operate as a client of another group. A Wi-Fi direct device that does not support the concurrent operation may operate as only an owner of a group or a client of a group.

Wi-Fi direct devices may form a group and invite other devices to the group. A group owner or a group client forming a group may invite other devices to the group formed by them. However, when a device directly gives a request to participate in a group, the request to participate in the group may be given only to the group owner.

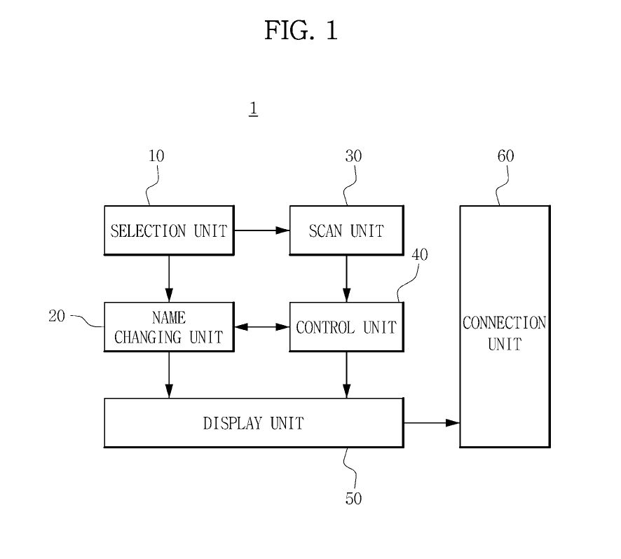

FIG. 1 is a block diagram illustrating a terminal device according to exemplary embodiments of the present disclosure.

Referring to FIG. 1, a terminal device 1 according to the present disclosure supports a Wi-Fi direct and includes a scan unit 30, a control unit 40, and a display unit 50. The terminal device 1 may further include a selection unit 10, a name changing unit 20, and a connection unit 60.

The terminal device 1 is a device that may perform Wi-Fi direct communication with neighborhood devices (hereinafter, Wi-Fi direct devices) that support the Wi-Fi direct. The terminal device 1 may include mobile devices, such as, smartphones, portable telephones, tablet computers, net-books, Personal Digital Assistants (PDAs), Personal Media Players (PMPs), and game consoles, and other electronic devices that communicate, such as, desktop computers, smart cameras, smart TVs, printers, and facsimiles.

The terminal device 1 may execute various application programs based on an operating system (OS). The operating system is a system program that enables an application program to use the hardware of a terminal device. The operating system may include mobile operating systems, such as, ANDROID OS, IOS, WINDOWS MOBILE OS, BADA OS, SYMBIAN OS, BLACKBERRY OS, or the like, which can be provisioned on mobile terminals. The operating system may include computer operating systems of WINDOWS-based computers, LINUX-based computers, UNIX-based computers, MAC, AIX, HP-UX, or the like.

An application program is a program that is developed to execute a specific task using a computer. The application program may include various kinds of applications and various kinds of multimedia contents, such as, games, moving images, and photos and execution programs, such as, image viewers and moving image players executing the multimedia contents.

At least one of the selection unit 10, the name changing unit 20, the scan unit 30, and the control unit 40, and the connection unit 60 may configure a Wi-Fi direct module.

The terminal device 1 provides convenience to users while scanning and connecting with neighborhood Wi-Fi direct devices to use a Wi-Fi direct service. In particular, the terminal device 1 may collect information regarding itself, i.e., the present terminal device 1, and information regarding the neighborhood Wi-Fi direct devices, distinguish available Wi-Fi direct devices from non-available Wi-Fi direct devices to provide information regarding these devices to the users, and provide information regarding the states of the scanned Wi-Fi direct devices.

When a Wi-Fi direct operation is activated in the terminal device 1, the selection unit 10 selects whether the terminal device 1 operates as a group owner (P2P Group Owner) or operates as a P2P (Peer-to-Peer) device.

For example, the selection unit 10 may provide a UI to a user and conform to a user's input at the time of the selection. Further, the selection may be automatically performed according to an environment of the terminal device 1. When the Wi-Fi direct operation is performed, the terminal device 1 may be configured to operate as the P2P device, and then the state of the terminal device may be changed to the group owner according to a user's subsequent selection.

The name changing unit 20 understands the current state of the terminal device 1 and changes the name of the terminal device 1, for example, to a name that indicates state information. The name changing unit 20 changes the name of the terminal device 1 to a name indicating the group owner or the P2P device selected by the selection unit 10.

When the terminal device 1 is selected as the P2P device and then operates as the group owner or the group client, the name changing unit 20 may change the name indicating the P2P device to a name indicating a group owner or a group client. The name changing unit 20 may cause information regarding whether the concurrent operation is supported to be included in the name of the terminal device 1.

The scan unit 30 scans the neighborhood Wi-Fi direct devices. The scan unit 30 transmits and receives probe request messages and probe response messages corresponding to the probe request messages to and from the neighborhood Wi-Fi direct devices.

The probe request message and the probe response message are information transmitted to investigate connection possibility and responded to the investigation. The probe request message and the probe response message may include state information of the Wi-Fi direct device transmitting a message and group information of a group to which the device belongs.

For example, the probe request message may include identification information, for example, a Media Access Control (MAC) address, of the Wi-Fi direct device transmitting the probe request message, information regarding whether the terminal device is a group owner, information regarding whether a group is formed, and information regarding whether the concurrent operation is supported.

The probe response message may include identification information, for example, a MAC address, of the Wi-Fi direct device transmitting the probe response message and information regarding a group. When the Wi-Fi direct device transmitting the probe response message is the group owner, the information regarding the group may include identification information, for example, a Service Set Identifier (SSID), of the group and identification information (for example, a MAC address) of a group client belonging to the group.

The control unit 40 analyzes or parses packets of the probe request message and the probe response message, and determines information regarding the scanned Wi-Fi direct devices and the terminal device 1. Based on the analyzed information, the control unit 40 determines whether the scanned Wi-Fi direct devices are available Wi-Fi direct devices or non-available Wi-Fi direct devices.

The control unit 40 analyzes the state of each of the scanned Wi-Fi direct devices and the state of the terminal device 1, and determines whether each of the scanned Wi-Fi direct devices is an available device or a non-available device according to the state of the terminal device 1. The terminal device 1 need not be connected to all of the other Wi-Fi direct devices and is distinguished as an available device or a non-available device according to the self-state.

The control unit 40 confirms the self-state of the terminal device 1, analyzes the packets of the probe request message and the probe response message, and confirms the state of each of the scanned Wi-Fi direct devices. Thus, the available Wi-Fi direct devices are distinguished from the non-available Wi-Fi direct devices, and information regarding whether connection may be possible is provided to the display unit 50. The description thereof will be made in more detail below.

The display unit 50 displays information regarding the scanned Wi-Fi direct devices. The display unit 50 distinguishes the available Wi-Fi direct devices from the non-available Wi-Fi direct devices according to the determination of the control unit 40 and may display the available Wi-Fi direct devices. Further, the display unit 50 may display the available Wi-Fi direct devices and the non-available Wi-Fi direct devices by visually distinguishing the available Wi-Fi direct devices from the non-available Wi-Fi direct devices according to the determination of the control unit 40. The display unit 50 may display the states of the Wi-Fi direct devices and group information together.

The display unit 50 may display the information regarding the scanned Wi-Fi direct devices in a list form and provide various User Interfaces (UIs) so that the user can easily use the information. For example, the display unit 50 may also display the terminal device of the user and the neighborhood scanned Wi-Fi direct devices graphically.

According to exemplary embodiments, only the available Wi-Fi direct devices may be displayed without displaying the non-available Wi-Fi direct devices in a list, or the Wi-Fi direct devices may be displayed by assigning a visual effect so that the user can intuitively recognize the available and non-available Wi-Fi direct devices.

For example, the non-available Wi-Fi direct devices may be displayed according to a visual effect, such as, monochrome processing, dimming processing, definition adjustment, transparency adjustment, cobweb processing, mosaic processing, or the like. According to exemplary embodiments, the non-available Wi-Fi direct devices are inactivated in the selection so that a connection attempt to a non-available device is not performed even when a user selects a non-available Wi-Fi direct device. As a method for displaying the state of the scanned Wi-Fi direct devices or the group information, for example, the states or the group information may be divided into categories and may be displayed, or the respective states or the group information may be displayed with the names of the Wi-Fi direct devices. In this way, the Wi-Fi direct devices may be displayed in various methods.

Accordingly, since the user may recognize the available Wi-Fi direct devices through the display unit 50, the user may attempt to perform Wi-Fi direct connection with only the available Wi-Fi direct devices.

The connection unit 60 may attempt to perform the connection to the Wi-Fi direct device selected by the user or the automatically selected Wi-Fi direct device.

Thus, in the present disclosure, since whether to make the connection with the Wi-Fi direct devices is visually displayed, the user may promptly recognize whether to make the Wi-Fi direct connection. Accordingly, it is possible to improve convenience and efficiency of the user who uses the Wi-Fi direct service.

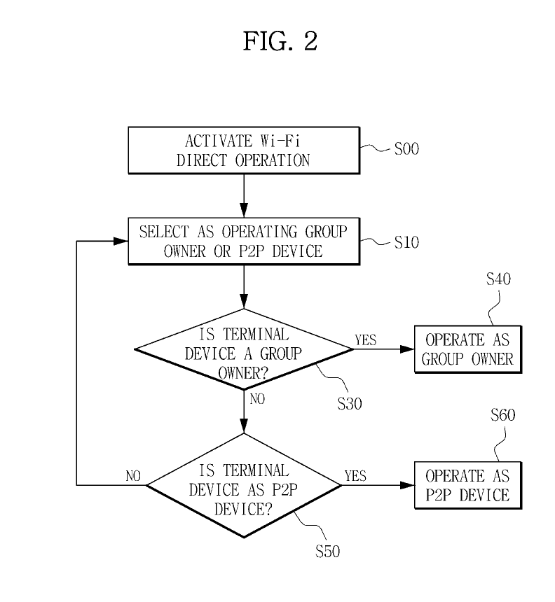

FIG. 2 is a flowchart illustrating a selection process in which a terminal device operates as a group owner or a P2P device.

Referring to FIG. 2, when a Wi-Fi direct operation is activated in the terminal device that supports the Wi-Fi direct, that is, the Wi-Fi direct operation is turned on (operation S00), the terminal device may be set or selected to operate as the group owner (P2P Group Owner) or a P2P (Peer-to-Peer) device (operation S10).

The user is provided with a selection UI to perform operation S10 and the selection may be performed according to a user's input. According to exemplary embodiments, the selection may be performed automatically according to an environment of the terminal device, and thus operation S10 may be omitted.

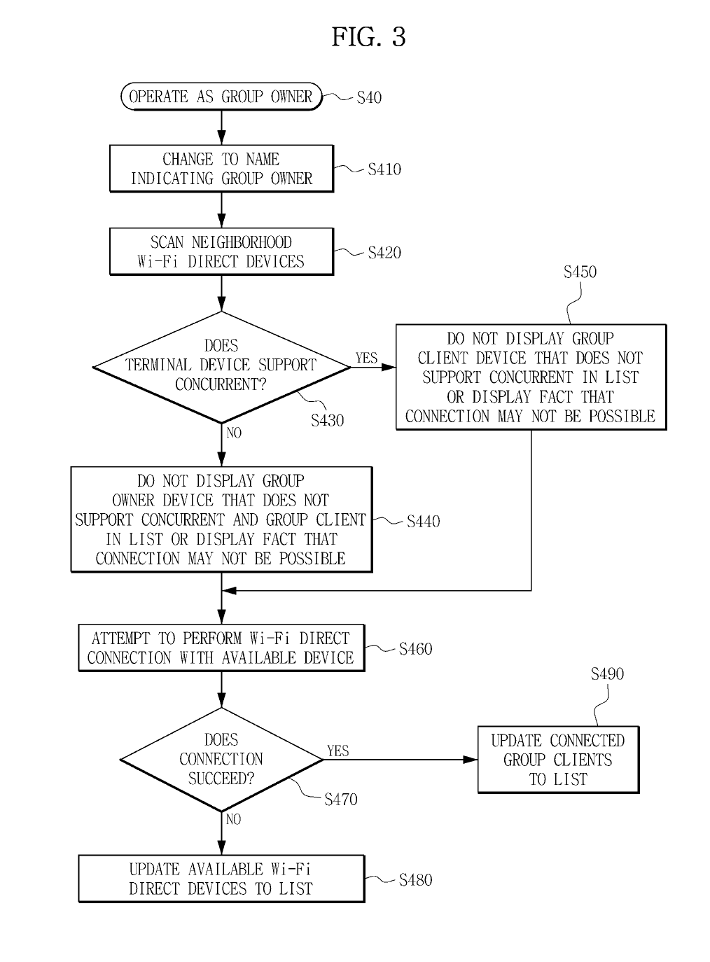

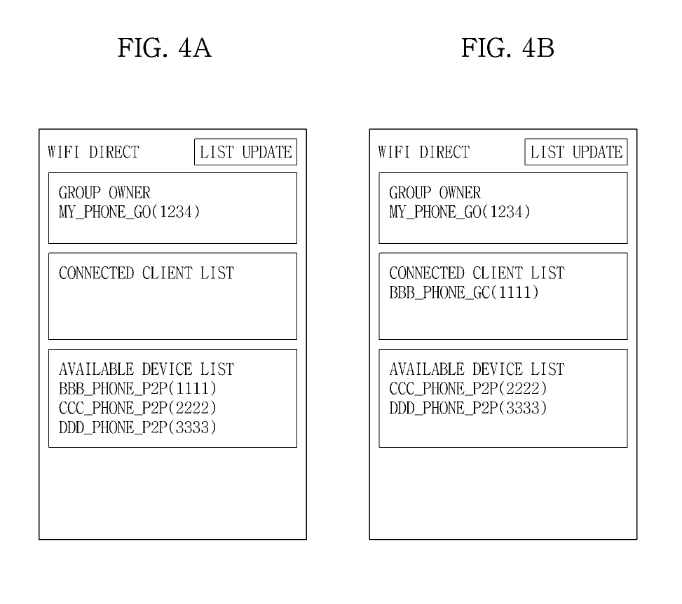

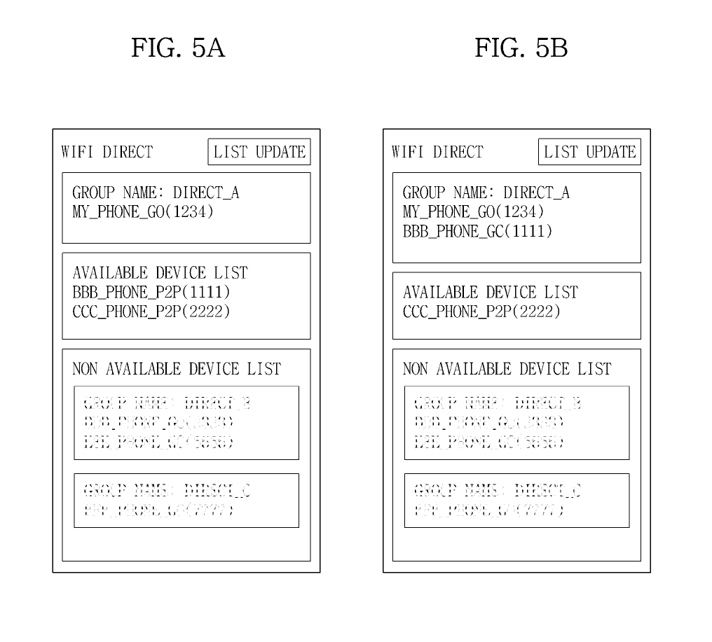

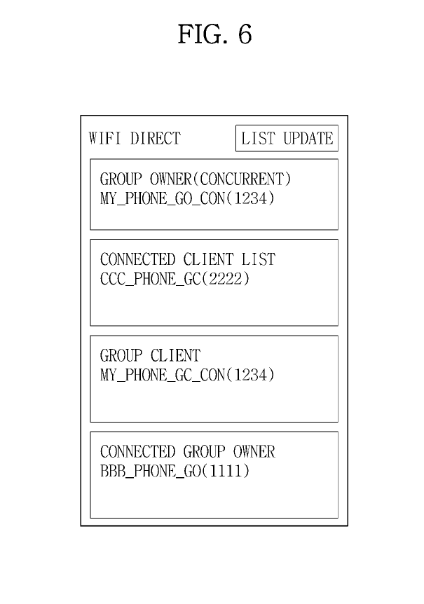

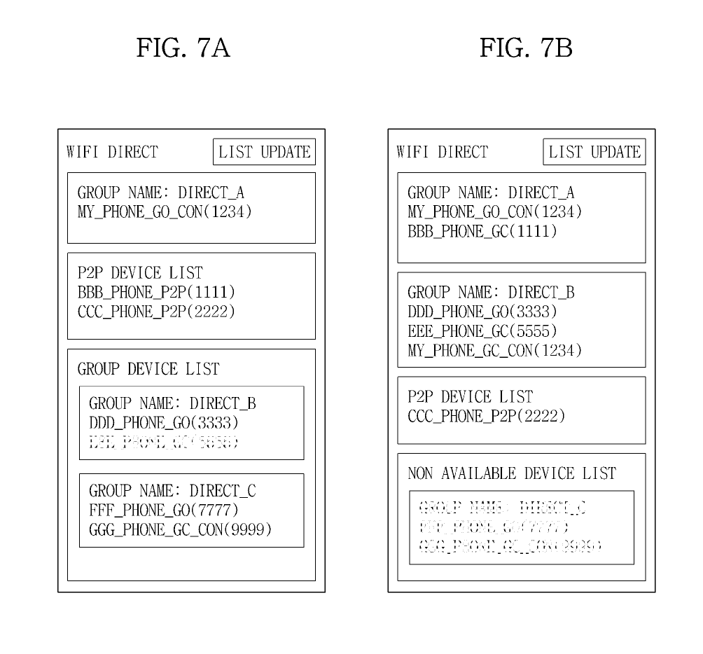

When the terminal device is selected as the group owner (operation S30), the terminal device subsequently operates as the group owner (operation S40). A process in which the terminal device operates as the group owner will be described in detail below with reference to FIG. 3, FIG. 4A, FIG. 4B, FIG. 5A, FIG. 5B, FIG. 6, FIG. 7A and FIG. 7B.

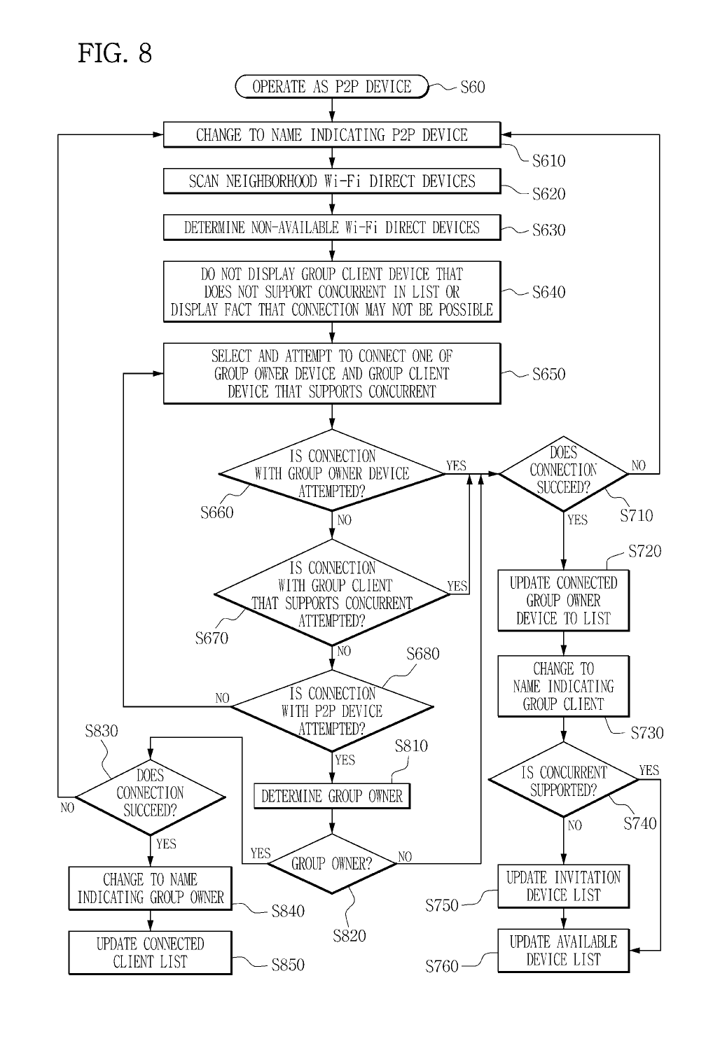

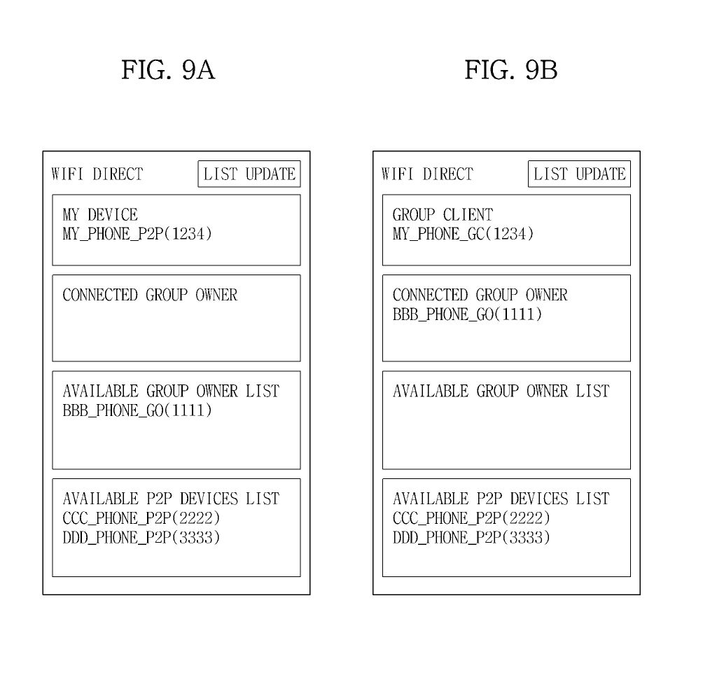

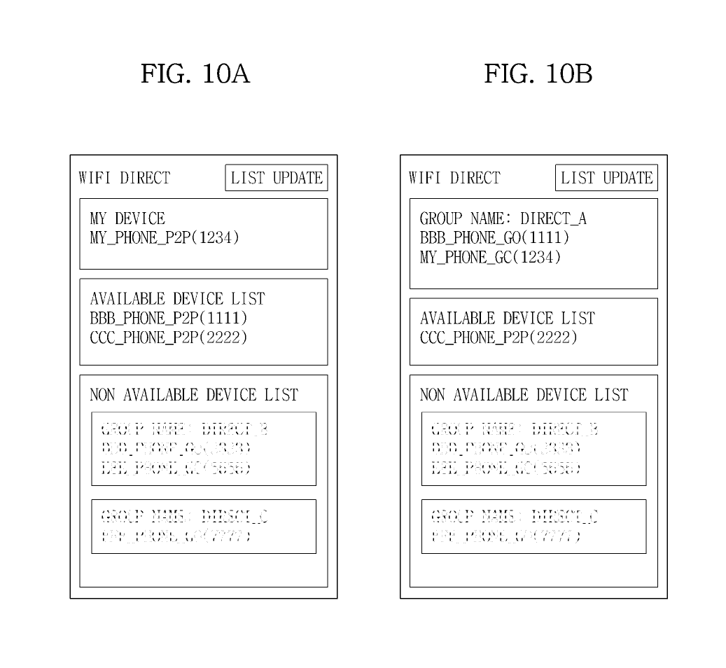

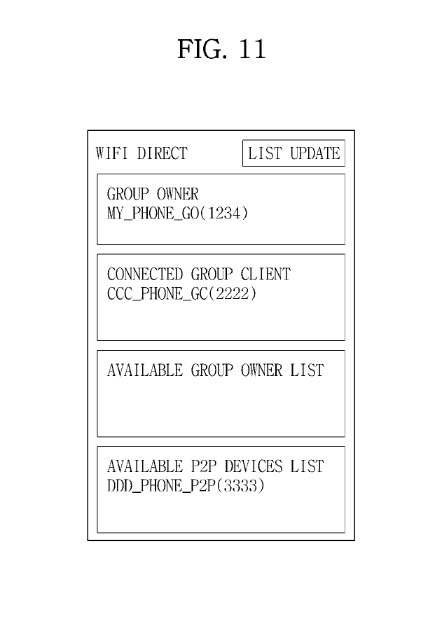

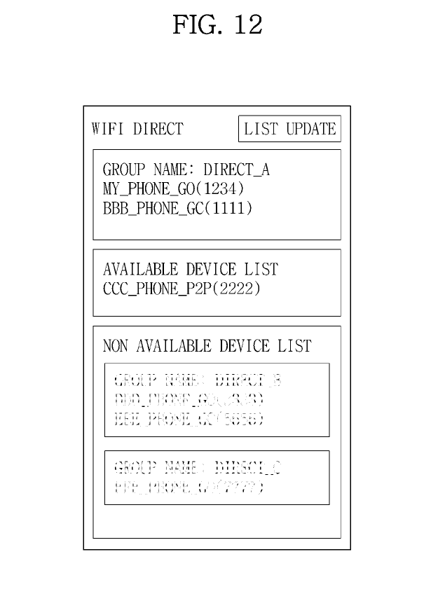

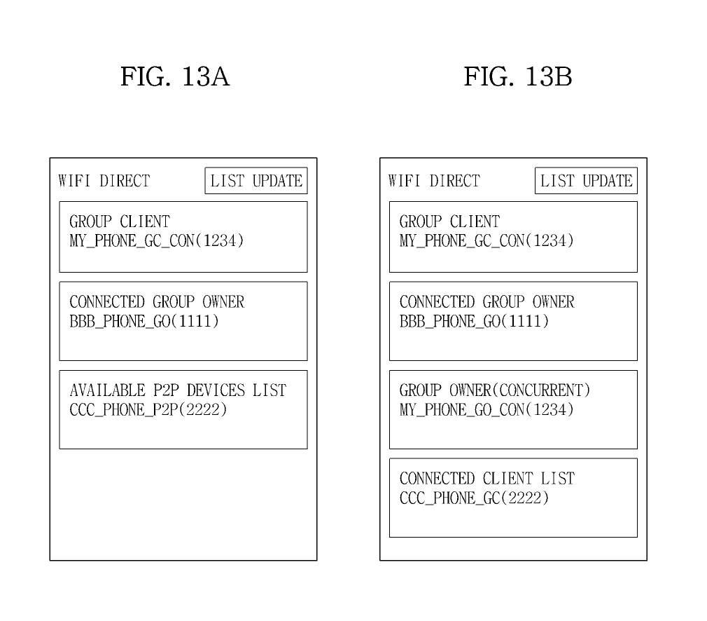

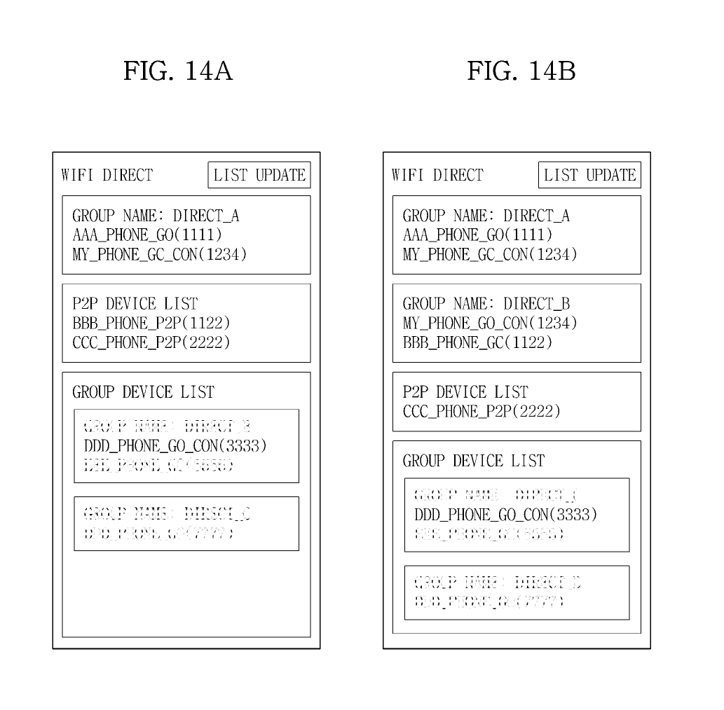

When the terminal device is selected as the P2P device (operation S50), the terminal device subsequently operates as the P2P device (operation S60). A process in the terminal device operates as the P2P device will be described in detail below with reference to FIG. 8, FIG. 9A, FIG. 9B, FIG. 10A, FIG. 10B, FIG. 11, FIG. 12, FIG. 13A, FIG. 13B, FIG. 14A and FIG. 14B.

FIG. 3 is a flowchart illustrating the process in which the terminal device operates as the group owner according to exemplary embodiments.

Referring to FIG. 3, when the terminal device starts operating as the group owner (operation S40), the name of the terminal device may be changed to a name indicating the group owner (operation S410). In exemplary embodiments, operation S410 may be omitted.

The terminal device scans the neighborhood Wi-Fi direct devices (operation S420). The terminal device transmits the probe request messages and receives the corresponding probe response messages to and from the neighborhood Wi-Fi direct devices.

The probe request message includes information regarding the Wi-Fi direct device. For example, the probe request message may include identification information, for example, a MAC address, of the Wi-Fi direct device transmitting the probe response message, information regarding the terminal device that is the group owner, information regarding whether a group is formed, and information regarding whether the concurrent operation is supported.

The probe response message may include identification information, for example, a MAC address, of the Wi-Fi direct device transmitting the probe response message and information regarding the group. For example, when the Wi-Fi direct device transmitting the probe response message is the group owner, the information regarding the group may include identification information (for example, an SSID) of the group and identification information (for example a MAC address) of a group client belonging to the group.

The terminal device determines and analyzes the state information regarding the self-terminal device and information regarding the scanned Wi-Fi direct devices to determine whether connection is possible. The terminal device receives the state information regarding the terminal device and the information regarding whether the concurrent operation is supported from a Wi-Fi direct module. The Wi-Fi direct module may operate in a firmware or a kernel of an operating system. The terminal device receives, from the Wi-Fi direct module, the state indicating whether the terminal device operates as the group owner, the group client, or the P2P device of the terminal device, the group (an SSID or the like) to which the terminal device belongs when the terminal device is the group owner or the group client, and information regarding whether the terminal device supports the concurrent operation. The terminal device may parse the packets of the probe request message and the probe response message, determine and analyze the information regarding the scanned Wi-Fi direct devices, and determine whether to make the connection based on the analysis result.

The terminal device determines whether the own terminal device supports the concurrent operation (operation S430).

When the terminal device is a group owner that does not support the concurrent operation, the terminal device may not connect with both a group owner device (of another group) that does not support the concurrent operation and a group client device (including both a device that supports the concurrent operation and a device that does not support the concurrent operation).

When the terminal device is a group owner that does not support the concurrent operation, the terminal device may operate as only the group owner. Therefore, the terminal device may connect with only a device that may participate as a group client in the group in which the terminal device is the group owner. That is, the terminal device may connect with a group owner device and a P2P device (of another group) that support the concurrent operation.

As the group owner device of another group that supports the concurrent operation, the group owner device may operate as a group client, or the group owner device may be caused to participate in the group in which the terminal device operates as the group owner. As the P2P device may participate in the group and operate as a group client, the P2P device may be caused to participate in the group in which the terminal device operates as the group owner.

Accordingly, the terminal device distinguishes available Wi-Fi direct devices from the non-available Wi-Fi direct devices and displays the available Wi-Fi direct devices and the non-available Wi-Fi direct devices (operation S440). That is, the terminal display does not display the group owner device that does not support the concurrent operation and the group client device in the list, or displays the fact that the connection may not be possible (operation S440).

The fact that the connection may not be possible may be displayed by displaying the non-available Wi-Fi direct devices visually differently according to a visual effect, such as, monochrome processing, dimming processing, definition adjustment, transparency adjustment, cobweb processing, mosaic processing, or the like.

Conversely, when the terminal device is a group owner that supports the concurrent operation, the terminal device may not connect with a group client (P2P Group Client) device (of another group) that does not support the concurrent operation.

When the terminal device is the group owner that supports the concurrent operation, the terminal device operates as the group owner or the group client. Therefore, the terminal device may connect with a device that may participate as a group client of a group in which the terminal device is the group owner or may connect with a group owner device of another group. That is, the terminal device may connect with a group owner device of another group (a group owner device that may or may not support the concurrent operation), and a group client device and a P2P device that support the concurrent operation.

When the terminal device is the group owner that supports the concurrent operation, the terminal device may participate as a group client in another group. Therefore, the terminal device may connect with the group owner device of another group. That is, the terminal device may connect with the group owner device of another group as a group client of the group. At this time, whether the group owner device of another group may support concurrent operation is not considered. When the group owner device of another group supports the concurrent operation, the group owner device may be caused participate as the group owner in a group client in the group in which the terminal device belongs as the group owner.

When the terminal device is the group client device that supports the concurrent operation, the terminal device may form a group as the group owner. Therefore, the terminal device may connect in such a manner that the terminal device participates as the group client of the group of the formed group. Since the P2P device participates and operates as group client in the group, the P2P device may also participate in the group in which the terminal device is the group owner. Accordingly, the terminal device does not display the group client device that does not support the concurrent operation in the list or displays the fact that the connection may not be possible in order to distinguish the available Wi-Fi direct devices from the non-available Wi-Fi direct devices and display the available Wi-Fi direct devices and the non-available Wi-Fi direct devices (operation S450).

Since the terminal device distinguishes the available Wi-Fi direct devices from the non-available Wi-Fi direct devices and displays Wi-Fi direct devices and the non-available Wi-Fi direct devices in operation S440 and operation S450, the terminal device may attempt to perform the Wi-Fi direct connection with only the available Wi-Fi direct devices (operation S460). At the time of the connection, the terminal device may attempt to connect with a Wi-Fi direct device selected by the user or an automatically selected Wi-Fi direct device.

The terminal device distinguishes the available Wi-Fi direct devices from the non-available Wi-Fi direct devices and displays the available Wi-Fi direct devices and the non-available Wi-Fi direct devices in operation S430, operation S440 and operation S450, and may also display the state (whether the terminal device is the group owner, the group client, or the P2P device and whether the concurrent operation is supported) of each of the scanned Wi-Fi direct devices and information regarding the group to which the terminal device belongs. Accordingly, based on the displayed information, the user may appropriately select a Wi-Fi direct device necessary to be connected.

An operation of updating and displaying the available Wi-Fi direct devices and the non-available Wi-Fi direct devices according to the result of the connection attempt may be further included (operation S470, operation S480 and operation S490).

When the connection fails, the available Wi-Fi direct devices are updated to the list (operation S480). When the connection succeeds, the connected group client may be updated to the list (operation S490). Further, when the connection succeeds, not only the connected group client but also the other available Wi-Fi direct devices may be updated to the list.

Hereinafter, the process described with reference to FIG. 3 will be described exemplifying specific screens. Each list and screen may be provided in a User Interface (UI) form and a list update UI may be added according to selection of the user. In FIG. 4A, FIG. 4B, FIG. 5A, FIG. 5B, FIG. 6, FIG. 7A, FIG. 7B, FIG. 9A, FIG. 9B, FIG. 10A, FIG. 10B, FIG. 11, FIG. 12, FIG. 13A, FIG. 13B, FIG. 14A and FIG. 14B, exemplary indicators to illustrate the states of the scanned Wi-Fi direct devices are disclosed. For example, a device having a name that has a GO suffix indicates a group owner, a GC suffix indicates a group client, a P2P suffix indicates a P2P device, and a CON suffix indicates a case in which the concurrent operation is supported. A case in which the concurrent operation is not supported is indicated by not displaying a CON suffix. However, it is emphasized that the screens are merely exemplary screens.

FIG. 4A and FIG. 4B are diagrams illustrating exemplary screens when a terminal device operates as a group owner that does not support a concurrent operation according to exemplary embodiments.

Referring to FIG. 4A, the terminal device (device name: 1234) is selected and operates as a group owner. A suffix (for example, GO) indicating the group owner is appended to a device name “MY_PHONE.”

In this case, a group owner device and a group client device (including both a device that supports the concurrent operation and a device that does not support the concurrent operation) that may not connect with the terminal device and does not support the concurrent operation are not displayed, or the fact that the connection may not be possible is displayed. That is, of the scanned Wi-Fi direct devices, a group owner device and a P2P device (of another group) that support the concurrent may be displayed as available devices.

In the exemplary screen of FIG. 4A, a connected client list (CONNECTED CLIENT LIST) and an available device list (AVAILABLE DEVICE LIST) are formed. The available device list is a list of the devices that may connect with the terminal device (1234) as group clients. When the available device list is displayed, the state (for example, P2P in a case of a P2P device) of each device may be displayed. Accordingly, since only the available Wi-Fi direct devices are displayed in the list, an attempt to connect with only the available Wi-Fi direct devices may be performed.

Referring to FIG. 4B, the screen is an updated screen when connection with BBB_PHONE_P2P (1111) displayed in the available device list in FIG. 4A succeeds. That is, the screen is the updated screen when BBB_PHONE_P2P (1111) participates in the group of MY_PHONE_GO (1234) as a group client. The name of BBB_PHONE_P2P (1111) (see FIG. 4A) is changed from a name (for example, P2P) indicating a P2P device to a name (for example, GC) indicating a group client, and BBB_PHONE_GC (1111) is added to the connected client list.

FIG. 5A and FIG. 5B are diagrams illustrating exemplary screens when a terminal device operates as a group owner that does not support a concurrent operation according to exemplary embodiments. The example of FIG. 5A and FIG. 5B is different from that of FIG. 4A and FIG. 4B in that lists are formed utilizing a group name.

Referring to FIG. 5A, the terminal device operates as the owner of group A. An available device list (AVAILABLE DEVICE LIST) and a non-available device list (NON AVAILABLE DEVICE LIST) are separately formed. In the exemplary screen of FIG. 5A, non-available devices are shown dimmed or gray. In this case, the non-available Wi-Fi direct devices displayed in gray are inactivated for selection. Therefore, even when the user erroneously selects a non-available Wi-Fi direct device, no connection attempt is performed.

Referring to FIG. 5B, the screen is an updated screen when connection with BBB_PHONE_P2P (1111) succeeds among the devices displayed in the available device list in FIG. 5A. That is, the screen is the updated screen when BBB_PHONE_P2P (1111) participate as a group client in the group of the device with the name of MY_PHONE_GO (1234). The name of BBB_PHONE_P2P (1111) is changed from a name (for example, P2P) indicating the P2P device to a name (for example, GC) indicating the group client, and BBB_PHONE_GC (1111) is added to the list of group A.

FIG. 6 is a diagram illustrating an exemplary screen when a terminal device operates as a group owner that supports a concurrent operation according to exemplary embodiments.

Referring to FIG. 6, a suffix (for example, GO) indicating that the terminal device operates as the group owner is appended to a name (for example, CON) indicating that the concurrent operation is supported are suffixed to MY_PHONE.

In this case, a group client device may not connect with the terminal device and does not support the concurrent is not displayed, or the fact that the connection may not be possible is displayed. That is, it is possible to display the fact that connection with the group owner device (which is a device that supports the concurrent operation or does not support the concurrent operation), a group client device that supports the concurrent operation, and a P2P device (of another group) is possible.

In the exemplary screen of FIG. 6, the terminal device (MY_PHONE) operates as the group owner, is invited from the owner of another group, and operates as the group client. The connection and the operation state of the terminal device (MY_PHONE) can be understood easily by the name. Although not illustrated in FIG. 6, an available device list (AVAILABLE DEVICE LIST) may be additionally displayed.

FIG. 7A and FIG. 7B are diagrams illustrating exemplary screens when a terminal device operates as a group owner that supports a concurrent operation according to exemplary embodiments. The example of FIG. 7A and FIG. 7B is different from that of FIG. 6 in that lists are formed utilizing a group name.

Referring to FIG. 7A, the terminal device (device name: 1234) operates as the owner of group A, and the lists of group B and group C which are other groups are separately formed.

When the terminal device does not support the concurrent, the terminal device may not connect with devices of the other groups. Therefore, information regarding the other groups is not necessary. However, when the terminal device supports the concurrent operation, the terminal device may connect with group owners belonging to the other groups and group clients that support the concurrent operation. Therefore, the information regarding the other groups is displayed.

In the exemplary screen of FIG. 7A, non-available Wi-Fi direct devices of the other groups are shown with gray. In FIG. 7A, an available device list (AVAILABLE DEVICE LIST) is not divided for display and the available devices are displayed with black. However, this display method is, of course, merely an example.

Referring to FIG. 7B, the screen is an updated screen when the terminal device is invited to group B and connection succeeds. It is possible to understand that the terminal device (MY_PHONE) is the owner of group A and simultaneously operates as a client of group B. On the other hand, when the terminal device supports the concurrent operation, the terminal device may operate as the group owner and the group client only once. Accordingly, when the terminal device (1234) operates as both the owner of group A and a client of group B, as in FIG. 7B, the terminal device may not connect with the group owner device or a group client device belonging to another group. The fact that the terminal device may not connect with a Wi-Fi direct device belonging to group C is displayed. In this state, the terminal device (1234) may additionally connect, as the owner of group A, with only the P2P device or the group owner device of another group that supports the concurrent operation.

Hereinafter, a process in which the terminal device is selected and operates as the P2P device will be described.

FIG. 8 is a flowchart illustrating the process in which the terminal device operates as the P2P device according to exemplary embodiments.

Referring to FIG. 8, when the terminal device starts operating as the P2P device (operation S60), the name of the terminal device may be first changed to a name indicating the P2P device (operation S610). In exemplary embodiments, operation S10 may be omitted.

The terminal device scans the neighborhood Wi-Fi direct devices (operation S620). Since a method for scanning the neighborhood Wi-Fi direct devices is substantially the same as the method described with reference to FIG. 3, the repeated description will be omitted.

The terminal device determines and analyzes the state information regarding the self-terminal device and information regarding the scanned Wi-Fi direct devices to determine non-available Wi-Fi direct devices (operation S630). The terminal device may confirm the self-state information, parse the packets of the probe request messages and the probe response messages to confirm and analyze the information regarding the scanned Wi-Fi direct devices, and determine whether connection with the Wi-Fi direct devices scanned based on the self-state information is possible.

Subsequently, the terminal device distinguishes the available Wi-Fi direct devices from the non-available Wi-Fi direct devices and displays the available Wi-Fi direct devices and the non-available Wi-Fi direct devices (operation S640). That is, the terminal device does not display the group client device that does not support the concurrent operation in the list or displays the fact that the connection may not be possible.

Since the terminal device distinguishes the available Wi-Fi direct devices from the non-available Wi-Fi direct devices and displays Wi-Fi direct devices and the non-available Wi-Fi direct devices in operation S640, the terminal device may attempt to perform the Wi-Fi direct connection with only the available Wi-Fi direct devices (operation S650). That is, the terminal device may select and attempt to connect with one of the group owner device and a group client device that supports the concurrent.

The terminal device may operate as the group owner or the group client according to the result of the connection attempt, and updating and displaying the list may be included (see, for example, operations S660, S670, operation S680, S710, S720, S730, S740, S750, S760, S810, S820, S830, S840 and S850).

When the terminal device attempts to connect with the group owner device (operation S660), the terminal device determines whether the connection succeeds (operation S710). When the connection with the group owner device succeeds, the terminal device operates as a group client. Accordingly, the connected group owner device is updated to the list (operation S720) and the self-name is changed from the name indicating the P2P device to a name indicating the group client (operation S730). In exemplary embodiments, operation S730 may be omitted.

Subsequently, an operation of determining whether the present terminal device supports the concurrent operation and may be included (operation S740) is performed. When the present terminal device is a group client that does not support the concurrent operation, the terminal device operates as only the group client of the connected group. Therefore, there is no available Wi-Fi direct device, but the terminal device may invite the P2P device and the group owner device that supports the concurrent operation to the own group. Accordingly, an invitation device list may be updated (operation S750).

When the own terminal device is the group client device that supports the concurrent operation, the terminal device may form a new group and operate as the group owner, while operating as the group client of the connected group. Accordingly, the connection with a group owner device (of another group) that supports non-concurrent operation and a group client device (of another group) (irrespective of whether the concurrent operation is supported) may not be possible. On the other hand, since the terminal device may connect with the group owner device or the P2P device that supports the concurrent operation, the terminal device may update the available device list (operation S760). The Wi-Fi direct devices that may be invited may be displayed together.

When the terminal device does not attempt to connect with the group owner device in operation S650 above and attempts to connect with the group client that supports the concurrent (operation S670), the terminal device determines whether the connection succeeds (operation S710). That is, since the group client that belongs to a specific group and supports the concurrent operation, the group client may operate as a group owner while forming a new group. In this case, the group client participates in the new group as a group client. Subsequently, the terminal device operates as the group client. Therefore, since the method is substantially the same the method described in operations S720, S730, S740, S750 and S760, the repeated description is omitted.

When the terminal device does not attempt to connect with the group client that supports the concurrent in operation S670 above and attempts to connect with the P2P device (operation S680), the terminal device may perform a process of determining (negotiating) the P2P device with which the connection is attempted and the group owner (operation S810). For example, internal intent values of the Wi-Fi direct devices are compared and the device with the larger intent value may be determined as the group owner.

In the process of determining (negotiating) the group owner, it is determined whether the terminal device is determined as the group owner (operation S820). When the terminal device is not the group owner, the process proceeds to operation S710 and a process of a case in which the terminal device is connected as the group client is performed. Conversely, when the terminal device is determined as the group owner, the terminal device determines whether the connection with the P2P device succeeds (operation S830).

When the connection with the P2P device succeeds, the name (self-name) of the terminal is changed from the name indicating the P2P device to a name indicating the group owner (operation S840) and the connected client list is updated (operation S850). In exemplary embodiments, operation S840 may be omitted.

Even when the terminal device operates as the P2P device, selects the group owner, and then forms a group per the device of FIG. 8 (for example), the process of FIG. 3 may be performed. Therefore, the detailed description of FIG. 3 is omitted in this instance.

Hereinafter, the process described with reference to FIG. 8 will be described with exemplifying specific screens. After the terminal device may be selected as the P2P device, the state of the terminal device may be changed to the group client or the group owner.

First, a case corresponding to operation S710 to operation S760 of FIG. 8 will be described as a case in which the terminal device is selected as the P2P device and then operates as the group client.

FIG. 9A and FIG. 9B are diagrams illustrating exemplary screens when a P2P device operates as a group client that does not support a concurrent operation according to exemplary embodiments.

Referring to FIG. 9A, the terminal device is selected and operates as the P2P device. A suffix (for example, P2P) indicating a P2P device is suffixed to the value MY_PHONE.

In this case, the terminal device does not display the group client device that may not connect with the terminal device and does not support the concurrent operation or displays the fact that the connection may not be possible. In other words, the terminal device may connect with the group owner (including both a device that supports the concurrent operation and a device does not support the concurrent operation), the group client and the P2P device that support the concurrent operation.

In the exemplary screen of FIG. 9A, only available Wi-Fi direct devices are displayed in the list. Therefore, the terminal device may attempt to connect with only the available Wi-Fi direct devices.

Referring to FIG. 9B, the screen is the updated screen when the connection with BBB_PHONE_GO (1111) displayed in the available device list in FIG. 9A succeeds. BBB_PHONE_GO (1111) is updated to the connected group owner device list, and the self-name of device 1234 is changed from the name indicating the P2P device to a name indicating a group client.

When there is no available Wi-Fi direct device, but a P2P device and a group owner device that supports the concurrent operation may be invited to the own group. Accordingly, a list of devices that may be invited may be updated (AVAILABLE GROUP OWNER LIST and AVAILABLE P2P DEVICE LIST).

FIG. 10A and FIG. 10B are diagrams illustrating exemplary screens when a P2P device operates as a group client that does not support a concurrent operation according to exemplary embodiments. The example of FIG. 10A and FIG. 10B is different from that of FIG. 9A and FIG. 9B in that lists are formed utilizing a group name.

Referring to FIG. 10A, the terminal device operates as a P2P device, and an available device list and a non-available device list are separately formed. In the exemplary screen of FIG. 10A, non-available Wi-Fi direct devices are shown as dimmed or gray.

Referring to FIG. 10B, the screen is an updated screen when the connection with BBB_PHONE_P2P (1111) succeeds among the devices displayed in the available device list in FIG. 10A and the group client operates as a group client. The name of BBB_PHONE_P2P (1111) is changed from a name (for example P2P) indicating the P2P device to a name (for example, GO) indicating the group owner. The self-name of device 1234 is changed from a name indicating the P2P device to a name (for example, GC) indicating the group client.

Since the terminal device operates as a group client that does not support the concurrent operation and may not connect with Wi-Fi direct devices of other groups, the terminal device is displayed as dimmed or gray. However, since the terminal device may invite the P2P device and the group owner device that supports the concurrent operation, the terminal device is displayed in the list.

Next, a case will be described in which the terminal device operates as a group owner after being selected as a P2P device and operations corresponding to operation S810 to operation S850 of FIG. 8 are performed.

FIG. 11 is a diagram illustrating an exemplary screen when a P2P device operates as a group client that does not support the concurrent operation according to exemplary embodiments.

Referring to FIG. 11, the state of the terminal device 1234 is changed from the P2P device to the group owner, and thus a name (for example, GO) indicating the group owner is suffixed to MY_PHONE. Since there is no name (for example, CON) indicating a device that supports the concurrent operation, it can be understood that the terminal device 1234 does not support the concurrent operation.

In this case, the terminal device 1234 does not display a group owner device that may not connect with the terminal device 1234 and does not support the concurrent operation and a group client device (including both a device that supports the concurrent operation and a device that does not support the concurrent operation), or displays the fact that connection may not be possible.

In the exemplary screen of FIG. 11, a connected client list, an available group owner list, and an available P2P device list are formed. Accordingly, since only the available Wi-Fi direct devices are displayed in the list, the terminal device may attempt to connect only with the available Wi-Fi direct devices.

FIG. 12 is a diagram illustrating an exemplary screen when a P2P device operates as a group client that does not support the concurrent operation according to exemplary embodiments.

Referring to FIG. 12, the terminal device 1234 operates as the owner of group A. An available device list and a non-available device list are separately formed. In the exemplary screen of FIG. 12, the non-available Wi-Fi direct devices are displayed as dimmed or gray.

FIG. 13A and FIG. 13B are diagrams illustrating exemplary screens when a P2P device operates as a group client and a group owner that supports a concurrent operation according to exemplary embodiments.

Referring to FIG. 13A, the terminal device 1234 operates as a group client that supports the concurrent operation. BBB_PHONE_GO (1111) is displayed in a connected group owner list and CCC_PHONE_P2P (2222) is displayed in an available device list.

Referring to FIG. 13B, the screen is an updated screen when connection with CCC_PHONE_P2P (2222) displayed in the available device list in FIG. 13A succeeds. The terminal device 1234 is connected to CCC_PHONE_P2P (2222) to form a new group and operates as the group owner. That is, the terminal device 1234 operates as a client of one group and operates as the owner of another group.

FIG. 14A and FIG. 14B are diagrams illustrating exemplary screens when a P2P device operates as a group client and a group owner that supports a concurrent operation according to exemplary embodiments. The example of FIG. 14A and FIG. 14B is different from that of FIG. 13A and FIG. 13B in that lists are formed utilizing a group name.

Referring to FIG. 14A, the terminal device 1234 operates as a client of group A. A P2P device list and list of another group are formed. In the exemplary screen of FIG. 14A, non-available Wi-Fi direct devices are displayed with gray.

Referring to FIG. 14B, the screen is an updated screen when connection with BBB_PHONE_P2P (1122) succeeds among devices displayed in the available device list in FIG. 14A. The terminal device 1234 is connected to BBB_PHONE_P2P (1122) to form new group B and operates as the group owner.

The name of BBB_PHONE_P2P (1122) is changed from a name (for example, P2P) indicating a P2P device to a name (for example, GO) indicating the group owner. The name of the terminal device 1234 is changed to a name indicating the group owner and is added to the list of group B.

In the method for scanning and connecting the Wi-Fi direct device according to exemplary embodiments and the terminal device for the same, available devices and non-available devices are distinguished from each other and displayed. Therefore, the available devices may be recognized.

According to exemplary embodiments, whether the current terminal device and the neighborhood Wi-Fi direct devices are a group owner, a group client, or a P2P device is displayed. According to exemplary embodiments, whether the current terminal device and the neighborhood Wi-Fi direct devices support a concurrent operation is displayed. Therefore, the states of the current terminal device and the neighborhood Wi-Fi direct devices may be understood. Accordingly, a user may use the Wi-Fi direct service more efficiently.

According to exemplary embodiments, the scope of the devices to which the present disclosure is applied may be restricted to devices using MAC addresses of specific manufacturers, and product competitiveness may be improved.

Further, the exemplary embodiments of the present invention can be embodied as computer-readable codes on a computer-readable recording medium. The computer-readable recording medium includes all kinds of recording devices storing data that is readable by a computer system. The computer-readable code may be executed by a computer having a processor and memory.

Examples of the computer-readable recording medium may include, without limitation, read-only memories (ROMs), random-access memories (RAMs), (compact disc) CD-ROMs, magnetic tapes, floppy disks, optical data storage devices, and carrier waves (e.g., data transmission through the Internet). The computer-readable recording medium may be distributed over network connected computer systems so that the computer-readable code is stored and executed in a distributed fashion. Various programs, code, and code segments that may be utilized for realizing aspects of the present invention may be deduced by computer programmers skilled in the art.

Although the present invention has been described with reference to the embodiments shown in the drawings, these embodiments are illustrative only and those skilled in the art will appreciate that various modifications, additions and substitutions are possible, without departing from the technical protection scope of the present invention. Therefore, the true technical protection scope of the present invention should be defined by the technical spirit of the appended claims.

What is claimed is:

1. A terminal device to scan a Wireless Fidelity (Wi-Fi) direct device, the terminal device comprising:
a scan unit configured to activate a Wi-Fi direct operation and configured to scan for Wi-Fi direct devices in range to obtain device information;
a control unit configured to determine whether connection is available or non-available with each of the scanned Wi-Fi direct devices by analyzing the device information for each of the scanned Wi-Fi direct devices; and
a display unit configured to display the available Wi-Fi direct devices.

2. The terminal device of claim 1, wherein the display unit is further configured to display the non-available Wi-Fi direct devices.

3. The terminal device of claim 1, wherein the display unit is further configured to display the non-available Wi-Fi direct devices by visually distinguishing the available Wi-Fi direct devices from the non-available Wi-Fi direct devices.

4. The terminal device of claim 1, wherein the control unit determines whether connection is available according to the device information and a state of the terminal device.

5. The terminal device of claim 1, further comprising a name changing unit configured to, based on the device information, add a state indicator to a name of one or more of the Wi-Fi direct devices.

6. The terminal device of claim 5, wherein the state indicator indicates one or more of a group owner state, a group client state, a Peer-to-Peer (P2P) state, a concurrent operation state, a P2P group owner, and a group client.

7. The terminal device of claim 1, further comprising a selection unit configured to select whether the terminal device operates as a P2P group owner or as a P2P device.

8. The terminal device of claim 1, further comprising a connection unit configured to connect a selected available Wi-Fi direct device.

9. The terminal device of claim 8, wherein the connection unit connects to one of the available Wi-Fi direct devices, and the terminal device updates the available Wi-Fi direct devices after the connection.

10. The terminal device of claim 1, wherein the display unit is further configured to display information for a device selected from one or more of a group owner, a connected group client, a connected group owner, an available group owner, an available P2P device, a non-available device, a concurrent group owner, and a group device.

11. A method for scanning a Wireless Fidelity (Wi-Fi) direct device in a terminal device, the method comprising:
activating a Wi-Fi direct operation;
scanning Wi-Fi direct devices within range to obtain device information;
determining, with a processor, whether connection is available or non-available with each of the scanned Wi-Fi direct devices by analyzing the device information for each of the scanned Wi-Fi direct devices; and
displaying the available Wi-Fi direct devices.

12. The method of claim 11, further comprising displaying the non-available Wi-Fi direct devices.

13. The method of claim 11, further comprising displaying the non-available Wi-Fi direct devices by visually distinguishing the available Wi-Fi direct devices from the non-available Wi-Fi direct devices.

14. The method of claim 11, wherein the determining further comprises determining whether connection is available according to the device information and a state of the terminal device.

15. The method of claim 11, further comprising adding a state indicator, based on the device information, to a name of one or more of the Wi-Fi direct devices.

16. The method of claim 15, wherein the state indicator indicates one or more of a group owner state, a group client state, a Peer-to-Peer (P2P) state, a concurrent operation state, a P2P group owner, and a group client.

17. The method of claim 11, further comprising selecting whether the terminal device operates as a P2P group owner or as a P2P device.

18. The method of claim 11, further comprising connecting to a selected available Wi-Fi direct device.

19. The method of claim 18, further comprising updating the available Wi-Fi direct devices after the connecting.

20. The method of claim 10, wherein the displaying further comprises displaying information for a device selected from one or more of a group owner, a connected group client, a connected group owner, an available group owner, an available P2P device, a non-available device, a concurrent group owner, and a group device.
